(19) United States
(12) Patent Application Publication
(10) Pub. No.: US 2003/0167180 A1
(43) Pub. Date: Sep. 4, 2003

(54) System and methods for determining contract compliance

(76) Inventors: Gunil Chung, New York, NY (US); James E. Baker, Boulder, CO (US)

Correspondence Address: TESTA, HURWITZ & THIBEAULT, LLP, HIGH STREET TOWER, 125 HIGH STREET, BOSTON, MA, 02110, US

(21) Appl. No.: 10/087,180

(22) Filed: Mar. 1, 2002

(51) Int. Cl. G06F 17/60

(52) U.S. Cl. 705/1

(57) ABSTRACT

A system and method of determining compliance with a service level agreement. In one aspect, the method includes the step of receiving operational data from a service provider. The operational data is received from a software agent that is not related to the service provider. The received operational data is compared to at least one service level agreement requirement to determine compliance with that requirement and other contract provisions, such as, but not limited to penalties and/or rewards, including monetary and contractual.

### FIELD OF THE INVENTION

The invention relates generally to determining performance contract compliance and more specifically to automatically determining compliance with a service level agreement.

### BACKGROUND OF THE INVENTION

Improvements in communications and networking technology have changed the speed and manner in which business is conducted. It is now possible and useful for companies to outsource critical activities and functions that typically used to be functions of in-house departments, such as communications network management and information technology applications provision and management.

To help reduce the risk that is inherent in outsourcing business critical functionality, Service Providers (xSPs) often enter into legal contracts called Service Level Agreements (SLAs) with their customers. These SLAs typically specify (i.e., guarantee) the services to be performed, including the quality of service to be delivered. The SLAs often attempt to describe both service provider and customer expectations through the explicit definition of expected performance levels and functions. Just as one example, an SLA can be quite complex in the area of eCommerce, due to the complexity of services required and the difficulty involved in measuring or otherwise verifying such services. Generally, there are several specialized components (e.g., hosting, bandwidth, and back office processing) associated with an eCommerce application that are provided to a customer by one or more xSPs. Each component might have a separate SLA defining the services required, and specifying the expected quality levels of the services.

SLAs are much more meaningful if they can be verified, that is, if the service provision can be tracked and measured. Currently, many xSPs audit their own performance, and the customer of the xSP is dependent on reports generated by the xSP to determine SLA compliance. Often, each customer manually and independently determines compliance with its requirements using data provided by the xSP. This is a difficult and expensive task for customers who outsource critical business components to xSPs. The result is often ad hoc or perceptual measures that lead to customer dissatisfaction.

### SUMMARY OF THE INVENTION

Independent, automatic verification of compliance with SLAs would therefore be useful particularly such that it incorporates data from one or more sources, for example, from a customer site, or from third party information sources in addition to data from an xSP. The present invention is directed to a system and method that allows for the automatic collection and analysis of operational data to determine compliance with a service level agreement between the xSP and a customer of the xSP. This includes any corresponding contractual terms, such as financial and contractual penalties, e.g., the right to the terminate the contract. By providing an independent analysis of the operational data, the xSP can gain confidence among its customers about their ability to provide the contracted for services. The operational data is obtained from the xSP, and additional corroborative data can be obtained from customers of the xSP, xSPs customer's (i.e., users of the services) unrelated third parties, or some combination.

In one aspect, the invention relates to a method of determining compliance with at least one service level agreement requirement. The method includes the steps of receiving operational data from a service provider by an agent not related to the service provider, and comparing the received operational data to at least one service level agreement requirement to determine compliance.

The service provider can be at least one of an application service provider, an internet service provider, a hosting provider, a commerce service provider, a content service provider, a network service provider, a security service provider, a storage service provider, vertical service provider, and a wireless service provider. In one embodiment, the operational data includes performance data indicative of a performance level of a contracted-for service provided by the service provider to a customer.

In another embodiment, comparing the received operational data includes deriving episode data in response to the received operational data, deriving at least one fact relevant to the at least one service level agreement requirement in response to the episode data, and determining compliance with the service level agreement requirement in response to the derived at least one fact.

In still another embodiment, the service provider includes a database which includes data from at least one of an enterprise management system, a network management system and an application management system. In a further embodiment, the operational data includes events logged by at least one of the enterprise management system, network management system, and application management system.

In other embodiments, the agent is stand-alone hardware running a secure software program controlled by a party other than the service provider, and the agent is controlled by a party not related to, or not a party to, the service level agreement.

In another aspect, the invention relates to a method of determining compliance with at least one service level agreement requirement. The method includes receiving a first set of operational data from a service provider, receiving a second set of operational data from a customer, and comparing the first received set of operational data and the second received set of operational data to at least one service level agreement requirement to determine compliance with the at least one service level agreement requirement.

In another aspect the invention relates to a method of determining compliance with at least one service level agreement requirement. The method includes the steps of receiving a first set of operational data from a service provider, receiving a second set of operational data from a customer, receiving a third set of operational data from a third-party, and comparing the first received set of operational data, the second received set of operational data, and the third received set of operational data to at least one service level agreement requirement to determine compliance with the at least one service level agreement requirement.

In another aspect, the invention relates to a system for determining compliance with a service level agreement. The system includes a first agent, a first receiver, and an analyzer. The first agent is in communication with a service provider. The first agent includes software running on a stand-alone computer for requesting operational data from the service provider. The first receiver is in communication with the first agent, and the first receiver receives the operational data from the first agent. The analyzer is in communication with the first receiver. The analyzer extracts data corresponding to at least one service level agreement requirement from the received operational data, refines the extracted data to generate a service level data set related to at least one requirement of the service level agreement, and compares the service level data set at least one requirement of the service level agreement to determine compliance with the service level agreement.

In one embodiment, the system includes a second agent and a second receiver. The second agent is in communication with a customer. In a further embodiment, the system includes a third agent and a third receiver. The third agent is in communication with a third-party.

In one embodiment, the analyzer includes a quantizer and a data warehouse. The analyzer is in communication with the first receiver. The quantizer extracts data corresponding to service level agreement requirements from the received operational data, refines the extracted data to generate a service level data set related to a portion of requirements of the service level agreement, and compares the service level data set to the portion of the requirements of the service level agreement to determine compliance with the service level agreement. The data warehouse is in communication with the quantizer. The data warehouse stores at least the service level data set and compares a plurality of stored service level data sets to the portion of the requirements of the service level agreement to determine compliance with the service level agreement.

In another embodiment, the system includes a reporting module in communication with the data warehouse. The reporting module generates reports in response to customer requests.

In another aspect, the invention relates to a method for determining compliance with at least one term of an agreement for service between a customer and a service provider. The method includes the steps of receiving operational event data related to the performance of a service by a service provider, identifying at least one time period interval relevant to the at least one term in an agreement for service between a customer and the service provider, and deriving episode data in response to the received operational event data. The method also includes the steps of deriving at least one fact relevant to the at least one term in the agreement for service in response to the episode data and in response to the identified at least one time period interval relevant to the agreement for service, and determining compliance of the service provider to the at least one term in the agreement for service in response to the derived at least one fact.

In one embodiment, the step of deriving facts relevant to the at least one term in the agreement for service includes the step of sampling the episode data at the identified at least one time period relevant to the agreement for service. In a further embodiment, the step of deriving facts relevant to the at least one term in the agreement for service includes the step of sampling the episode data such that an aggregation of facts are used to derive the episode data.

In another embodiment, the method includes the step of notifying a user of the determined compliance of the service provider to the at least one term in the agreement. In a further embodiment, the user is associated with a party to the service level agreement. In still a further embodiments, the user is representative of the customer, and the user is representative of the service provider.

### BRIEF DESCRIPTION OF THE DRAWINGS

The advantages of the invention may be better understood by referring to the following description taken in conjunction with the accompanying drawings, in which:

FIG. 1 is a block diagram depicting an embodiment of the invention;

FIG. 2 is a block diagram depicting an embodiment of the service provider site of FIG. 1 constructed in accordance with the principles of the present invention;

FIG. 3 is a block diagram depicting an embodiment of an agent of FIG. 1 constructed in accordance with the principles of the present invention;

FIG. 4 is a block diagram depicting an embodiment of the analyzer of FIG. 1 constructed in accordance with the principles of the present invention;

FIG. 5 is a flow chart of an embodiment of a method for determining compliance with an SLA;

FIG. 6 is a flow chart depicting the steps associated with an embodiment of an agent; and

FIG. 7 is a flow chart depicting the steps associated with an embodiment of STEP 540 of FIG. 5.

### DETAILED DESCRIPTION OF THE INVENTION

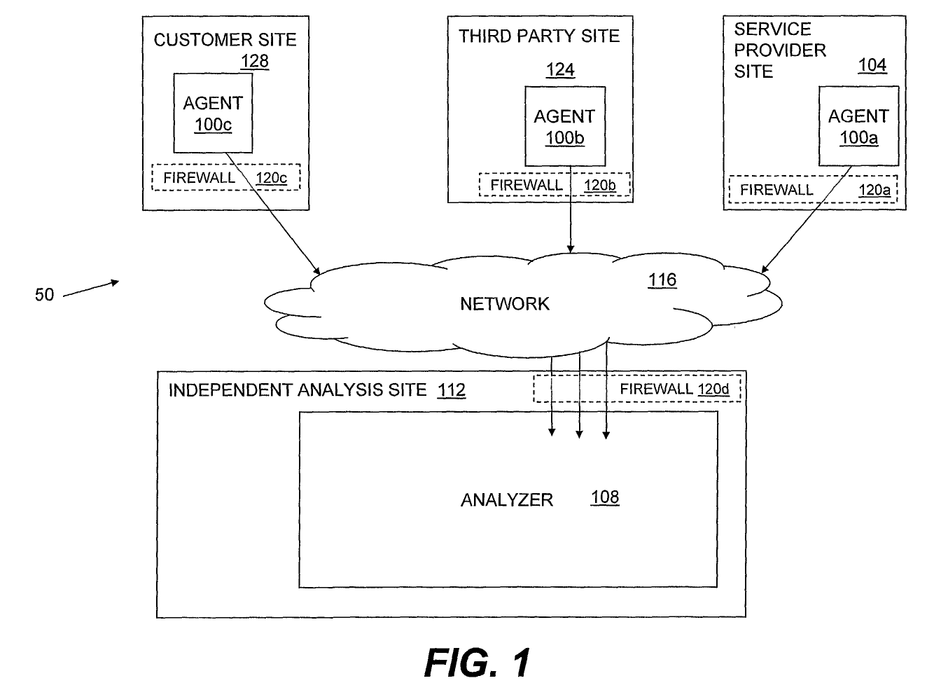

With reference to FIG. 1, a system 50 constructed in accordance with the principles of the present invention includes at least one service provider site agent 100a preferably residing on a service provider site 104, and an analyzer 108 preferably residing on an independent analysis site 112. The system 50 can include various agent/service provider site combinations, including multiple agents 100a and sites 104 and the shown in FIG. 1 is exemplary.

The agent 100a is in communication with the analyzer 108 through a network 116. The network can be a LAN or WAN, or some combination, and can include the internet. The network might include a direct connection or a virtual private network VPN. In one embodiment, the service provider site optionally includes a firewall 120a and the independent analysis site 112 optionally includes a firewall 120d as well. In such an embodiment, communication between the agent 100aand the analyzer 108 is passed through the firewalls 120a, 120d.

The system 50 optionally can include a third party site agent 100b located at a third party site 124. The third party site can be any party that can access or measure the services provided to the customer site 128. For example, if the services include provision of a web site, the third party can monitor the web site. The system 50 optionally can include a customer site agent 100c located at a customer site 128. Here, the customer is typically a party to a service level agreement (e.g., a customer of the service provider or a customer of the customer of the services). Each agent 100b, 100c communicates with the analyzer 108 through the network 116 and optionally through firewalls 120b, 120c, and 120d.

In operation, the agents 100a, 100b, 100c (referred to generally as 100) communicate operational data to the analyzer 108 through network 116. Each agent 100 may be the same or different network or connections than is used by another agent. The network 116 is shown as a single cloud for simplicity, but it should be understood that various network configurations are possible. Typically, the internet will be used for agent 100-analyzer 108 communication.

The analyzer 108 receives the operational data, and may filter out the data that is not relevant to a service level requirement, stores the extracted data, and determines compliance with each service level requirement, (which are also referred to as service level agreement requirements), of a service level agreement. This is described further below.

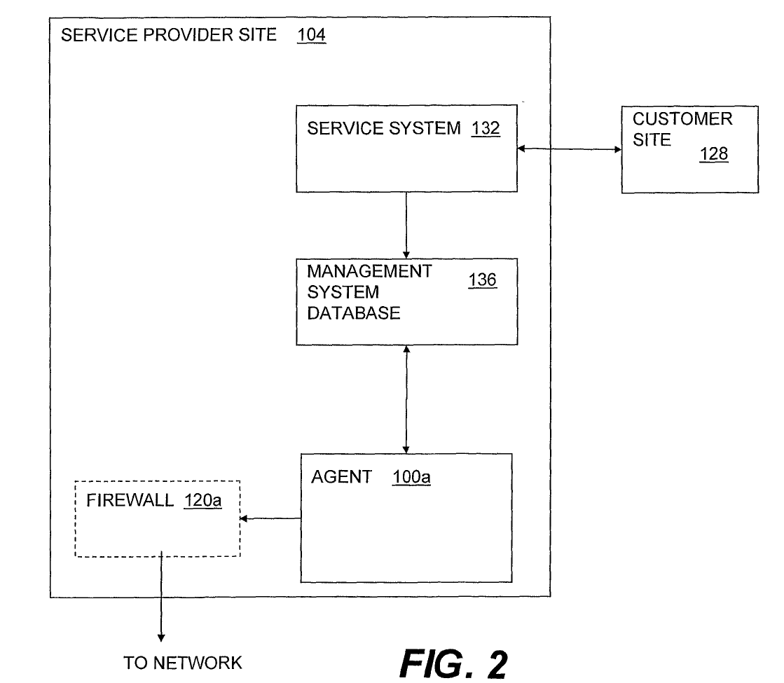

With reference to FIG. 2, in more detail, the service provider site 104 includes a service system 132, which is in communication with a management system database 136. The service system 132 thus provide one or more of the contracted for services to the customer site 128. Just to provide some examples, the service system might provide any or all of internet service, a web site, content, a word processing or other software application programs, routers, switches, or name servers. The service system 132 provides the contracted-for services to the customer site 128. The service provider site 104 might be, again just as some examples, one of (but not limited to): an application service provider, an internet service provider, a hosting provider, a commerce service provider, a content service provider, a network service provider, a security service provider, a storage service provider, vertical service provider, or a wireless service provider.

In one embodiment, the service system 132 and the management system database 136 are components of an enterprise management system. Examples of enterprise management systems include HP OPENVIEW sold by Hewlett-Packard Company of Palo Alto, Calif., TIVOLI sold by International Business Machines Corporation Armonk, N.Y., and CA UNICENTER sold by Computer Associates International, Inc. of Islandia, N.Y. These enterprise management systems generate and record element-level operational data that provide information about the performance of the service system 132. The operational data related to the delivery of the contracted-for service by the service system 132 is communicated to the management system database 136. The operational information is stored within the management system database 136.

Periodically, the agent 100a accesses the operational data stored within the management system database 136 and extracts the operational data. Typically, the agent 100a is authorized to request data from the management system database 136. Because the agent 100a is located at the service provider site 104, there is no need to allow access to the management system database 136 to computers outside the service provider site, which has security benefits. Alternatively or concurrently, it may be the case that the agent 100 also receives an event stream. The agent 100a establishes a secure communication link with the analyzer 108 using a secure transport protocol such as HTTPS. Using the secure protocol, the operational data is communicated through the network 116 to the analyzer 108 where it is processed to determine compliance with the service level agreement. By having the agent 100a initiate communication with the analyzer, the security of the system is increased, because the agent 100a does not have to be configured to allow connections initiated by other computers on the network.

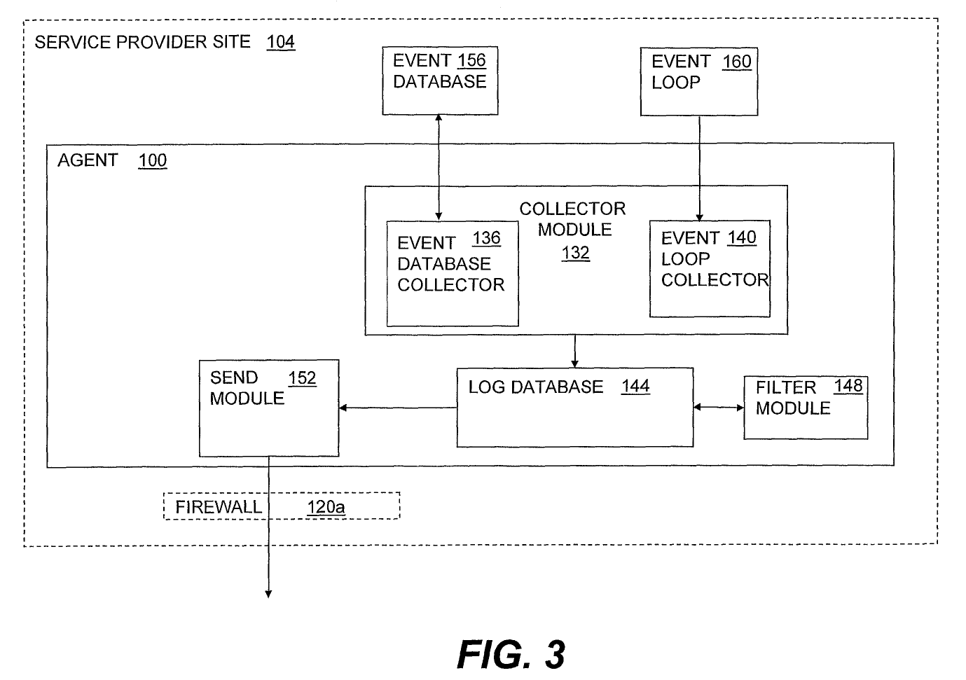

With reference to FIG. 3, a typical embodiment of an agent 100 includes a collector module 132, which includes an event database collector module 136 and an event loop collector module 140. One or both of these modules may be used depending on the service provider, customer site, or third party site implementation. Events are actions or responses of a service system at a specific time, for example, a service interruption, a service returning to normal operation, a measurement exceeding a threshold, or a measurement describing the current value of a system parameter. The event database collector module 136 and the event loop collector module 140 represent two types of event sources, an event repository and an event loop (also referred to as an “event pump”). The event source may store events in an event database (also referred to as a “repository”). In one embodiment, the event database can be queried asynchronously by a standard mechanism, such as a software query language or SQL.

Alternatively, the event source may modularize its processing of events through an event loop. A component of the system 50 can register with the event loop and receive events synchronously at various stages in the processing pipeline, and optionally modify or generate new events. The event database collector module 136 communicates with an event database 156 which resides on the service provider site 104 as part of the enterprise management system. The event pump collector module 140 communicates with an event loop 160 that resides on the service provider site 104.

In one embodiment, the server is not owned by the service provider or even by any party to the service level agreement. This allows for an independent party (e.g., the independent analysis site) to determine compliance with the service level agreement between the xSP and the customer.

In one embodiment, to ensure the integrity of the operational data stored in the agent 100, the communication between the agent 100 and the service provider site 104 is one-way (i.e., from the service provider site 104 to the agent 100). The agent only queries the records of the enterprise management system present on the service provider site 104. In such an embodiment, the event database collector module 136 queries an event database 156 (e.g., Information Technology Operations (ITO) tables that are part of HP OPENVIEW) using a standard query language such as SQL. The queries are designed to access active and historical data stored within the event database 156. The query searches for specific flags or indicators generated by the enterprise management system as part of the operational data that is stored in the event database 156. The results of the query are copied and forwarded to the log database 144. The log database can also be a first-in first-out (FIFO) batching mechanism.

In one embodiment, an event loop collector 140 is an instance of a class code in the Java programming language, which may incorporate the use of other classes, that is registered with the event loop to receive specific events (which are listed in the registration) from an event loop 160 (e.g., FORMULA sold by Managed Objects, Inc., of McLean, Va. In another embodiment, an event loop collector 104 is a dynamically loaded shared library written using the C programming language, which implements the appropriate API (e.g., HP OPENVIEW). In another embodiment, an event loop collector 140 includes, in part, a set of rules loaded by an event processor and runs as part of its event loop (e.g., TIVOLI TEC). The event loop collector 140 stores the received event data in the log database 144.

The log database 144 receives the event specific operational data from the collector module 132. If the event information contains state information related to, for example, an application or hardware component, some of the operational data may be filtered by the filter module 148. Information will have a state if it includes information related to a mode or condition of operation (e.g., bandwidth allocation is “high”, “medium”, or “low”; or a given server is “up”, “down”, or “in maintenance”). If the SQL search is constructed narrowly, i.e., to retrieve specific operational data, the filter module may not be needed. The filter module 148 can filter out the operational data useful for service level agreement evaluation. Thus, the relevant operational data is queued in the log database 144 until it is sent to the analyzer 108.

A send module 152 periodically securely transmits the operational data to the analyzer 108. In one embodiment, the operational data is transmitted using a secure protocol such as Hypertext Transfer Protocol over the Secure Socket Layer (HTTPS), or by encrypting the data and using a protocol such as Simple Mail Transfer Protocol (SMTP). In one embodiment, the operational data is encoded using a user-defined or preexisting XML schema, such as the Boulder schema used in bioinformatics. In another embodiment, the operational data is encoded in XML and transmitted over the HTTP protocol through the use of the SOAP standard protocol for web services. In another embodiment, the XMP-PRC standard for encoding and transmitting data over HTTP is used. In one embodiment, the standard Perl “Data::Dumper” serialization is used, and the Data::Dumper serialization converts Perl data structures into a text representation that is suitable for use by the analyzer 108.

Serialization is the representation of structures resident in the memory of one computer process such that they can be transmitted via a network or recorded persistently to a database or file. Another computer process can then receive or read this representation into its own memory, so that processing can be performed. Serialization manages such issues as aliasing, self-reference, and data format. Data::Dumper and XML both represent text representations of the data structures, which simplifies their debugging and enhances portability. This is especially the case for XML. SOAP, the simple object access protocol, defines both a XML serialization of data structures; and an usage of that for remote method calls. Such combinations, when expressed over the HTTP protocol are web services.

In a typical embodiment, the agent 100 is a stand-alone computer running software that enables the functions described herein. In one embodiment, each of the collector module 132, log database 144, filter module 148, and send module 152 are implemented as software modules running on a standalone, server-class computer. In some embodiments, multiple computers or processors are used for performance and scalability.

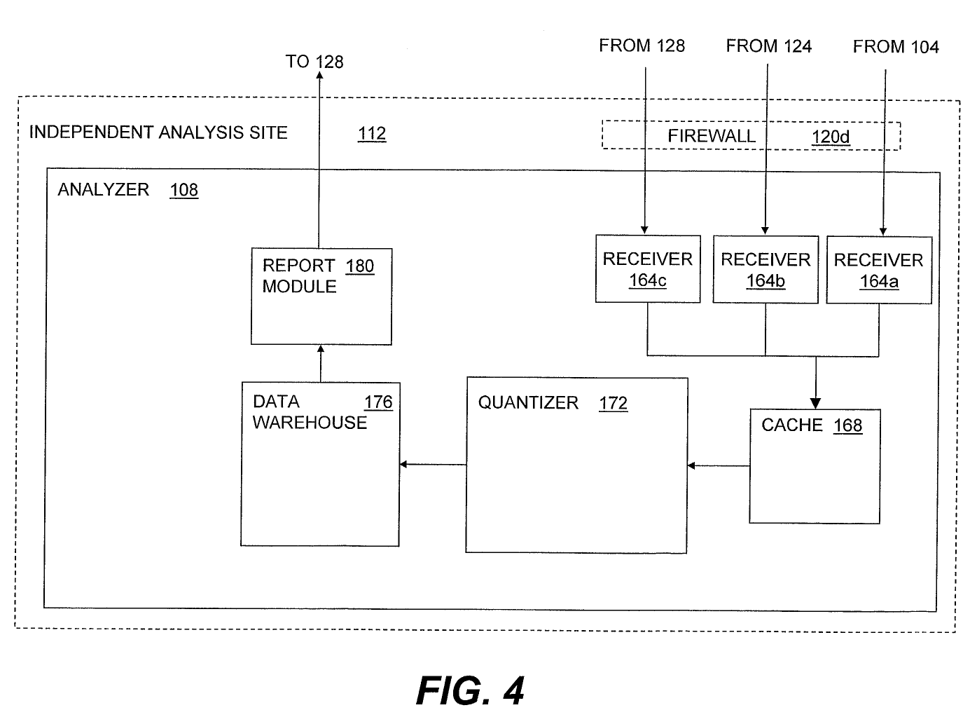

With reference to FIG. 4, in one embodiment, an analyzer 108 resides at the independent analysis site 112 preferably is implemented as one or more server-class computers with software modules each providing the functionality described below. In some embodiments, one module runs on different computers for performance and scalability. In one embodiment, the analyzer 108 includes one or more receivers 164a, 164b, 164c (referred to generally as receivers 164). The receivers 164 are used to receive data from one or more agents 100. One analyzer can be used with many agents, so multiple receivers 164 can be used. Alternatively, only a single receiver 164 is used, and that receiver 164 receives operational data from one or more agents 100. In one embodiment, a receiver 164 is embedded in a web server such as APACHE provided by the APACHE FOUNDATION (http:www.apache.org) for receiving https requests. In one embodiment, a receiver 164 is embedded in a SMTP server such as SENDMAIL sold by Sendmail, Inc. of Emeryville, Calif. for receiving electronic mail messages.

In operation, the receivers 164 receives the operational data via the secure transmission from the agent's send modules 152 through the network 116. The received operational data is then “normalized” such that the resulting records are all in a similar format that is usable to the quantizer 172. Time normalization of the operational data is also performed by the receiver 164. Normalization also can include converting operational data received from different sources, into a single format usable by the independent analysis site 112 to determine compliance. Various operational systems differ in their time formatting; for example, different systems can use different time zones, description of computer resources, placement of data into fields, or combining the time with annotations. The normalized data is then forwarded to the cache 168.

The cache 168 is a temporary data store which can be implemented as a database. The cache 168 is used to store the operational data once received and normalized by the receivers 164, prior to processing by the quantizer 172. The cache 168 may also be a batching mechanism.

The quantizer 172 receives the normalized operational data from the cache 168. The quantizer 172 performs extract, transform, and load functionality through the use of rule sets. The quantizer 172 converts the received operational data into “episodes” related to one or more terms of the service level agreement. An episode is a period of time in which a term of the SLA is in a consistent state (e.g., the server named TEST was off-line from 9:00 PM to 10:00 PM on a specific date. More specifically, the normalized operational data is filtered to contain information related to a specific episode. This filtered data or episodes are then aggregated into “facts”, which are stored in the form of actual service level values “ASLv”. Actual service level values can be compared to a specific service level requirement of a service level agreement. An actual service level value is a value assigned to the performance of an xSP for the specific service level for the specific time period, which can also include no service being provided. A detailed example of the transformation from operational data into ASLv is provided below.

The data warehouse 176 stores the facts related to the specific service level requirements. Customers of the xSP site 104 and the independent analysis site 112 can request a specific report from report module 180. In response, the report module 180 sends a request to the data warehouse 176 to obtain the facts, and the data warehouse 176 gathers and analyzes the data. The report module 180 then reports to the customer. In general, the report contains a determination of whether or not the xSP is in compliance with one or more portions of an SLA existing between an xSP and a customer. The report can be rendered to the customer in many formats, such as, but not limited to, paper or displayed on a computer screen.

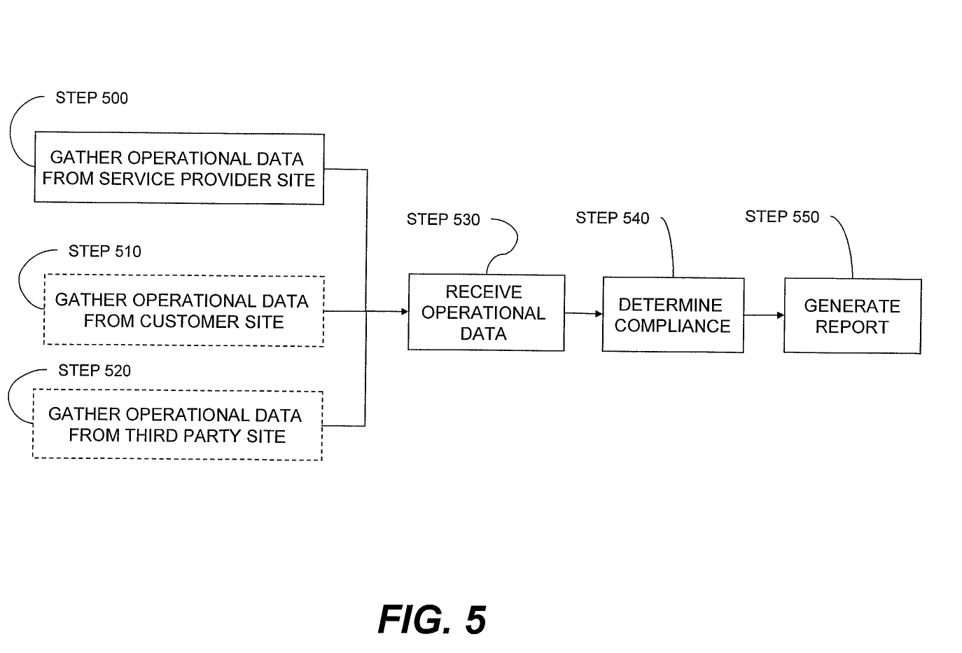

With reference to FIG. 5, in one embodiment, a method for determining compliance by an xSP to an SLA includes receiving operational data from a service provider site (STEP 500). Generally, one or more agents 100 gather operational data from xSP sites 104 and transmit the operational data to the independent analysis site 112.

Optionally, one or more agents 100b gather operational data from one or more third party sites 124 and transmit the operational data to the independent analysis site 112 (STEP 510). Optionally, the agent 100c gathers operational data from the customer site 128 and transmits the operational data to the independent analysis site 112 (STEP 520).

The operation data received (STEP 500, STEP 510, STEP 520) is used to determine compliance with the service level agreement between a customer and service provider xSP. In one embodiment, only the received operational data from the xSP site is used to determine compliance with the service level agreement. In another embodiment, the received operational data from at least two sources (e.g., a customer site 128 and the xSP site 104) is used to determine compliance with the service level agreement. In yet another embodiment, the operational data from each of the three sources is “triangulated” to determine compliance by the xSP site 104 with the service level agreement. At the request of a customer of the independent analysis site, which is typically one of the parties to a service level agreement, a report is generated that displays the results of the compliance determination (STEP 540).

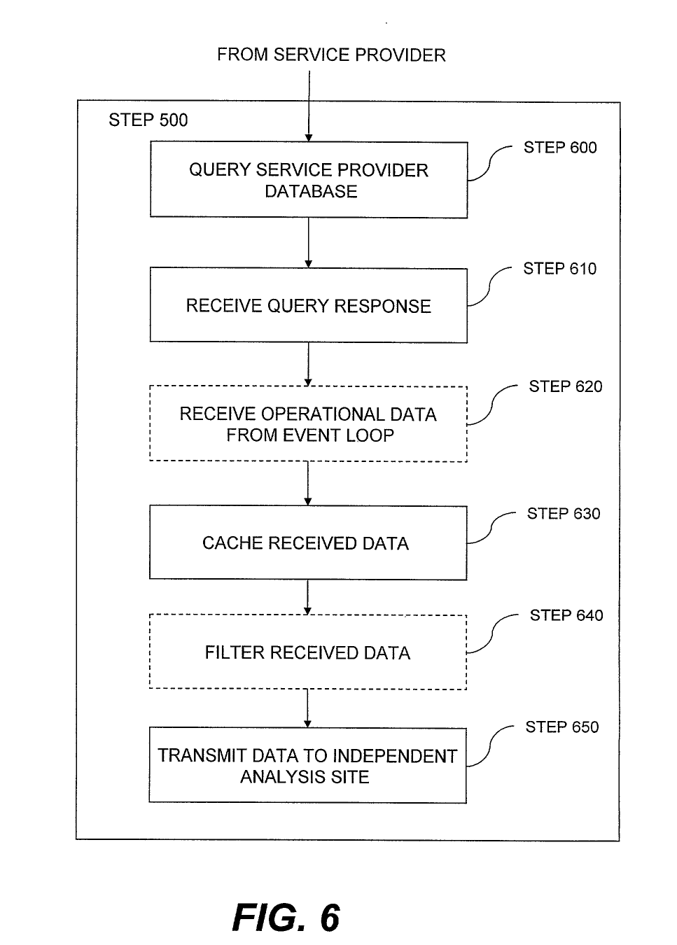

With reference to FIG. 6, in one embodiment, the operational data received (STEP 500 of FIG. 5) is collected and transmitted by an agent. As described above, the agent 100 is preferably resident at the xSP site 104 and queries a database or receives an event stream at the xSP site 104. The query performed by the agent is a read-only event to maintain the integrity of the operational data recorded by the enterprise management system. The query of the agent 100 can be directed to specific events or types of events. Generally, the query is constructed to retrieve the events specifically related to one or more portions of a service level agreement.

For example, if the agent 100 queries HP OPENVIEW with IT/OPERATIONS, the format of the stored records generated by HP OPENVIEW is recognized by the agent 100. Such format information can be found in a document entitled HP OPENVIEW VantagePoint Operations for UNIX Reporting and Database Schema, B7491-90004. The agent 100 primarily accesses the active and historical message tables (i.e., opc_act_messages and opc_hist_messages) generated by HP OPENVIEW. The events related to SLAs are generally stored in these tables. Generally, the agent 100 will need to access both active and historical tables, because the active table may be updated faster than it can be read by the agent 100. The message_number (which is the primary key) can be used to insure that duplicate messages in each table are recognized and filtered.

The message_number also can be used to determine the window of events to retrieve in an efficient way because it is a primary key and there is therefore an index on it. Another field that can be used to filter is the acknowledge flag (ackn_flag). In one embodiment, the agent 100 will not consider events actionable until they have been acknowledged.

The agent 100 receives the results of the query from the enterprise management system (STEP 610). Additionally, (or optionally) if the xSP site 104 includes an event loop 140, such as TIVOLI, operational data is received from the event loop 140 (STEP 620). In one embodiment, the agent 100 continually receives operational data from the event loop 140.

The operational data is stored in the log database 144 (STEP 630) until it is optionally filtered (STEP 640). The filtering (STEP 640) eliminates records that are not related to any service level agreement requirement. For example, an event may pertain to an aspect of some system element not covered by a SLA, or the event may be redundant Preferably, the query (STEP 600) will result in few events unrelated to at least one service level agreement requirement. The filtered operational data is transmitted to the independent analysis site 112 (STEP 650). In one embodiment, to maintain the integrity of the operational data, the operational data is encrypted prior to transmission. In one embodiment, a secure hash is computed on the data and added prior to transmission, which can also be used to guarantee the integrity of the data.

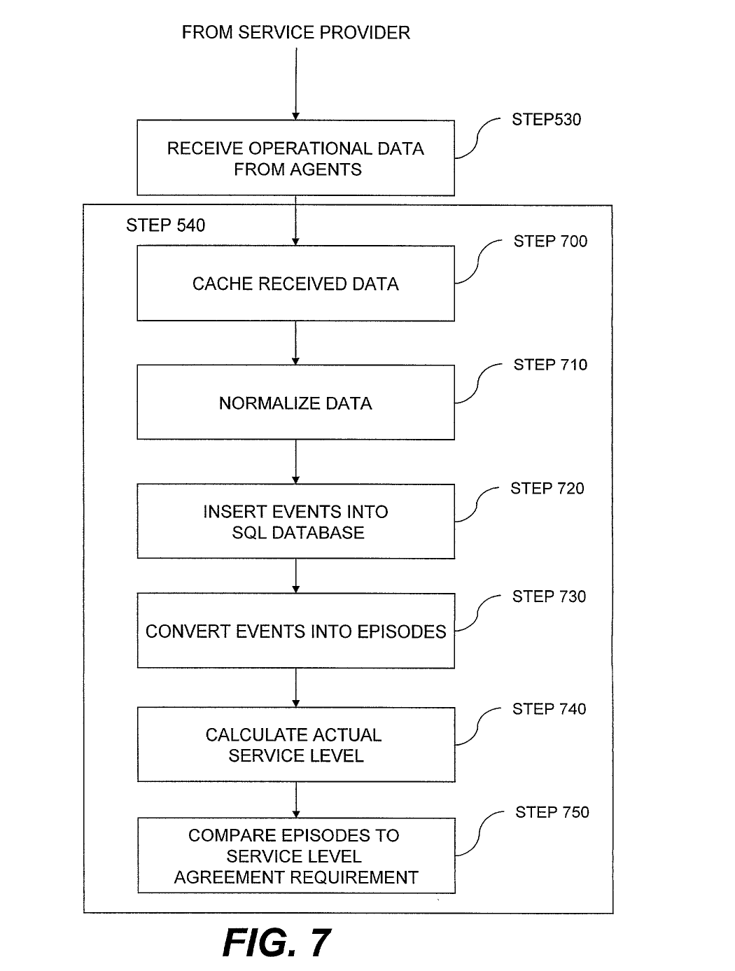

With reference to FIG. 7, the step of determining compliance (STEP 540 of FIG. 5) includes caching the encrypted operational data from the agent 100 that is received by the receiver 164 (STEP 700). The received operational data is cached for further processing. The received operational is validated and normalized (STEP 710). As described above, normalization refers to the process of converting operational data received from different sources into a single format usable by the independent analysis site 112 to determine compliance. The received operational data typically is time normalized as well as format normalized. In some embodiments, the independent analysis site 112 maintains a master clock and propagates the master time to the agents 100. The various enterprise management systems will use their own clocks to store operational data. The agents 100 may perform some normalization using a synchronization clock, but further normalization may be required. In one embodiment, the normalization of the data is not performed by the receiver and instead the normalization is performed in a separate module (not shown) located elsewhere in the system 50.

The normalized data can be stored in a data store, such as an SQL database (STEP 720) until a request to determine compliance with a service level agreement requirement is received. In one embodiment, the data store is the data warehouse 176 of FIG. 4. When a request to determine compliance is received, the stored operational data is processed to create episodes for a specific time period (STEP 730). The normalized events (e.g., servers going off-line and coming on-line) that occur during a specific time period (e.g., 9 PM to 10 PM on a specific date) are processed to generate a cumulative statistic for specific time intervals (e.g., the server was off-line for 15 minutes between 9:15 PM and 9:30 PM and another 5 minutes between 9:45 PM and 9:50 PM). In step 740, the actual service level of the xSP 104 site is calculated from the episodes (e.g., the server was offline two times for a total of 20 minutes). In step 750, the actual service level is compared against the service level agreement requirement and compliance or non-compliance is reported to the customer.

Triangulation

In certain aspects of the inventions, the independent analysis site 112 receives operational data from one or more of the service provider site 104, the customer site 128, the third party site 124. The operational data from the various sites can be used to help determine whether a violation of a service level agreement term occurred. In one embodiment, the third party site 128 is at least one of, but not limited to, KEYNOTE, sold by Keynote System, Inc., of San Mateo, Calif., or SITESCOPE/SITESEER, sold by Mercury Interactive Corporation, of Sunnyvale, Calif. or the like.

The operational data received from the multiple sites is time normalized as described above. In one embodiment, the triangulation is a statistical procedure in which data sets from multiple sources (e.g., xSP site 104 and customer site 128) are compared over a reporting period to compute a confidence level. In another embodiment, the triangulation is a mechanized audit process used to validate data in a specified time interval. This method is similar to comparing entries from multiple books or inventories in auditing accounting operations. If the entries match, confidence in the data is high, but if there are discrepancies among the data, a confidence in the data is lowered accordingly.

Each SLA can be broken down into detailed metrics and subcomponents called Service Level Objects (SLOs) or Service Level Requirements (the two terms used interchangeably), which can be defined and captured as discrete measures. For example, Company X guarantees that the average round trip packet loss for all network traffic will not exceed 1% edge-to-edge within the Company X network, as measured over a calendar month. In one embodiment, service level agreement terms are identified manually, and rules are set based on the SLOs. Enrollment of an SLA into an embodiment of the system consists of the following steps, proceeding top-down: 1) Identifying the various contractual outcomes in the SLA, including penalties and specifying the a computational process for deriving them, generally declaratively formulae in the data warehouse, as might be accomplished with SQL; 2) Identifying the service level objectives (SLOs) and specifying a computational process for deriving their compliance, generally declaratively through declarative formulae in the data warehouse, as might be accomplished with SQL; 3) Defining service levels corresponding to the SLOs and specifying a computational process by which actual service levels are to be summarized from episode data, generally declaratively through declarative formulae in the data warehouse, as might be accomplished with SQL; 4) Specifying the computation process by which episodes are to be constructed, generally declaratively through defined formulae in the quantizer, as might be accomplished with procedural scripts in Perl; 5) Specifying the computational process by which event data is to matched with defined service levels, generally declaratively through business logic rules in the quantizer.

One embodiment of this process assists an operator in the setup through an “expert” or “helper” system. A “wizard” program allows selection and specification of values.

One embodiment of the expert system may automatically validates the coverage of rules through the use of automated classification technologies, as used in data mining.

One embodiment of the computation of the compliance of the SLA can automatically process, via bottom-up application of the rules and formulae so defined, and record compliance, other summary results, intermediate results (episodes and facts), and the computational derivation so as to facilitate the inspection of any such results to the underlying events.

Having shown the preferred embodiments, one skilled in the art will realize that many variations are possible within the scope and spirit of the claimed invention. It is therefore the intention to limit the invention only by the scope of the claims.

What is claimed is:

1. A method of determining compliance with at least one service level agreement requirement, the method comprising the steps of:
receiving operational data from a service provider by an agent not related to the service provider; and
comparing the received operational data to at least one service level agreement requirement to determine compliance with at least one service level agreement requirement.

2. The method of claim 1 further comprising, before the receiving steps the step of requesting, by the agent, the operational data from the service provider.

3. The method of claim 1 wherein the step of receiving operational data comprises receiving performance data indicative of a performance level of a contracted for service provided by the service provider to a customer.

4. The method of claim 3 wherein the performance data comprise data indicative of the availability of a server adapted to provide a contracted for service to a customer of the service provider.

5. The method of claim 3 wherein the performance data comprises data indicative of a bandwidth level provided by the service provider to a customer.

6. The method of claim 3 wherein the performance data comprises data indicative of a response time to fulfill a request by a customer for a contracted for service.

7. The method of claim 1 wherein the service provider is at least one of an application service provider, an internet service provider, a hosting provider, a commerce service provider, a content service provider, a network service provider, a security service provider, a storage service provider, vertical service provider, or a wireless service provider.

8. The method of claim 1 wherein the step of comparing comprises:
filtering the received operational data; and
comparing the filtered operational data to the at least one service level agreement requirement to determine compliance with the service level agreement requirement.

9. The method of claim 8 further comprising storing the filtered operational data.

10. The method of claim 9 wherein the step of comparing comprises:
incorporating the filtered operational data with the stored operational data; and
comparing the incorporated operational data to the at least one service level agreement requirement to determine compliance with the service level agreement requirement.

11. The method of claim 1 wherein the step of comparing the received operational data comprises:
deriving episode data in response to the received operational data;
deriving at least one fact relevant to the at least one service level agreement requirement in response to the episode data; and
determining compliance with the service level agreement requirement in response to the derived at least one fact.

12. The method of claim 1 wherein the service provider comprises a database, the database comprises data from at least one of an enterprise management system, a network management system and an application management system.

13. The method of claim 12 wherein the receiving step comprises receiving operational data comprising events logged by the at least one of the enterprise management system, network management system and application management system.

14. The method of claim 1 wherein the agent comprises stand-alone hardware running a secure software program controlled by a party other than the service provider.

15. The method of claim 1 wherein the agent is controlled by a party not related to the service level agreement.

16. The method of claim 1 wherein the at least one service level agreement requirement is derived from at least one term of a service level agreement.

17. The method of claim 1 wherein the at least one service level agreement requirement comprises all of the terms of a service level agreement.

18. The method of claim 1 wherein the at least one service level agreement requirement comprises at least one service level guarantee.

19. The method of claim 1 wherein the at least one service level agreement requirement comprises at least one service level objective.

20. A method of determining compliance with a service level agreement requirement, the method comprising the steps of:
receiving a first set of operational data from a service provider;
receiving a second set of operational data from a customer; and
comparing the first received set of operational data and the second received set of operational data to at least one service level agreement requirement to determine compliance with the at least one service level agreement requirement.

21. The method of claim 20, wherein the step of comparing the received operational data comprises, for each of the first set of operational data and the second set of operational data:
identifying at least one time period interval relevant to the at least one term in an agreement for service between a customer and the service provider;
deriving episode data in response to the respective received operational data;
deriving at least one fact relevant to the at least one term in the agreement for service in response to the episode data and in response to the identified at least one time period interval relevant to the agreement for service; and
determining compliance of the service provider to the at least one term in the agreement for service in response to the derived at least one fact.

22. A method of determining compliance with a service level agreement requirement, the method comprising the steps of:
receiving a first set of operational data from a service provider;
receiving a second set of operational data from a customer;
receiving a third set of operational data from a third-party; and
comparing the first received set of operational data, the second received set of operational data, and the third received set of operational data to at least one service level agreement requirement to determine compliance with the at least one service level agreement requirement.

23. The method of claim 22, wherein the step of comparing the received operational data comprises, for each set of operational data:
identifying at least one time period interval relevant to the at least one term in an agreement for service between a customer and the service provider;
deriving episode data in response to the respective received operational data;
deriving at least one fact relevant to the at least one term in the agreement for service in response to the episode data and in response to the identified at least one time period interval relevant to the agreement for service; and
determining compliance of the service provider to the at least one term in the agreement for service in response to the derived at least one fact.

24. A system for determining compliance with a service level agreement comprising;
a first agent in communication with a service provider, the first agent comprising software running on a stand-alone computer for obtaining operational data from the service provider;
a first receiver in communication with the first agent, the first receiver receiving the operational data from the first agent; and
an analyzer in communication with the first receiver, the analyzer extracting data corresponding to at least one service level agreement requirement from the received operational data, refining the extracted data to generate a service level data set related to at least one requirement of the service level agreement, and comparing the service level data set at least one requirement of the service level agreement thereby determining compliance with the service level agreement.

25. The system of claim 24 further comprising:
a second agent in communication with a customer, the second agent comprising software running on a stand-alone computer for obtaining operational data from the customer data source; and
a second receiver in communication with the second agent and the analyzer, the second receiver receiving data stored in the customer data source from the second agent.

26. The system of claim 25 wherein the first receiver and the second receiver are the same receiver.

27. The system of claim 25 further comprising:
a third agent in communication with a third-party, the third agent comprising software running on a stand-alone computer for obtaining operational data from the third party; and
a third receiver in communication with the third agent and the analyzer, the third receiver receiving data from the third-party data source.

28. The system of claim 27 wherein the third receiver is the same as at least one of the first receiver and the second receiver.

29. The system of claim 24 further comprising a cache in communication with the first receiver, wherein the cache stores the received operational data.

30. The system of claim 24 wherein the analyzer comprises;
a quantizer in communication with the first receiver, the quantizer for extracting data corresponding to service level agreement requirements from the received operational data for refining the extracted data to generate a service level data set related to a portion of requirements of the service level agreement, and for comparing the service level data set to the portion of the requirements of the service level agreement to determine compliance with the service level agreement; and
a data warehouse in communication with the quantizer, the data warehouse for storing at least the service level data set and comparing a plurality of stored service level data sets to the portion of the requirements of the service level agreement to determine compliance with the service level agreement.

31. The system of claim 24 further comprising a reporting module in communication with the data warehouse, wherein the reporting module generates reports in response to customer requests.

32. The system of claim 24 wherein the service provider comprises a database, and the wherein the first agent is in communication with the database.

33. A method for determining compliance with at least one term of an agreement for service between a customer and a service provider, the method comprising the steps of:
a. receiving operational event data related to performance of a service by a service provider;
b. identifying at least one time period interval relevant to the at least one term in an agreement for service between a customer and the service provider;
c. deriving episode data in response to the received operational event data;
d. deriving at least one fact relevant to the at least one term in the agreement for service in response to the episode data and in response to the identified at least one time period interval relevant to the agreement for service; and
e. determining compliance of the service provider to the at least one term in the agreement for service in response to the derived at least one fact.

34. The method of claim 33 wherein the operational event data is generated by the system of the service provider.

35. The method of claim 33 wherein the operational event data is generated by the customer of the system of the service provider.

36. The method of claim 33 wherein the operational event data is generated by a computer that belongs to neither the service provider nor the customer.

37. The method of claim 33 wherein the operational event data comprises a list of events.

38. The method of claim 33 wherein the time period interval relevant to the at least one term in an agreement for service is identified automatically from the at least one term in the agreement for service.

39. The method of claim 33 wherein the determined episode data comprises a list of time periods in which a level of service was provided.

40. The method of claim 33 wherein the step of deriving facts relevant to the at least one term in the agreement for service comprises sampling the episode data at the identified at least one time period relevant to the agreement for service.

41. The method of claim 40 wherein the step of deriving facts relevant to the at least one term in the agreement for service comprises sampling the episode data such that an aggregation of facts are used to derive the episode data.

42. The method of claim 33 further comprising the step of:
f. notifying a user of the determined compliance of the service provider to the at least one term in the agreement.

43. The method of claim 42 wherein the user is associated with a party to the service level agreement.

44. The method of claim 43 wherein the user is representative of the customer.

45. The method of claim 43 wherein the user is representative of the service provider.

46. The method of claim 33, wherein the at least one term of the agreement comprise the service requirements of a service agreement, and wherein the at least one time period is the time periods relevant to the service requirements.
